(19) United States
(12) Patent Application Publication
(10) Pub. No.: US 2025/0273707 A1
(43) Pub. Date: Aug. 28, 2025

(54) SENSOR UNIT, FLUID CONDUCTION UNIT, FUEL CELL DEVICE, METHOD FOR CONTROLLING A DISCHARGE VALVE, CONTROL SYSTEM, AND MOTOR VEHICLE

(71) Applicant: EKPO Fuel Cell Technologies GmbH, Dettingen (DE)

(72) Inventors: Arni ANTAL, Dettingen (DE); Wadim KAISER, Dettingen (DE); Stefan HEMMER, Dettingen (DE); Jürgen KRAFT, Dettingen (DE)

(73) Assignee: EKPO Fuel Cell Technologies GmbH, Dettingen (DE)

(21) Appl. No.: 19/206,647

(22) Filed: May 13, 2025

Related U.S. Application Data
(63) Continuation of application No. PCT/EP2023/081020, filed on Nov. 7, 2023.

(30) Foreign Application Priority Data
Nov. 22, 2022 (DE) 10 2022 130 842.1

(51) Int. Cl. H01M 8/04119; H01M 8/04746

(52) U.S. Cl. CPC H01M 8/04164; H01M 8/04776; H01M 2250/20

(57) ABSTRACT

A sensor unit for a fluid conduction unit used for discharging liquid, for example for a fluid conduction unit used for discharging liquid from a fuel cell device, wherein the sensor unit comprises the following: at least one liquid level detection zone.

### RELATED APPLICATION

This application is a continuation of international application No. PCT/EP2023/081020 filed on Nov. 7, 2023, and claims the benefit of German application No. 10 2022 130 842.1 filed on Nov. 22, 2022, which are incorporated herein by reference in their entirety and for all purposes.

### FIELD OF DISCLOSURE

The present invention relates to the field of liquid separation, in particular the field of liquid separation from a fuel cell device for the drive of a motor vehicle.

### BACKGROUND

A fluid conduction unit for supplying fuel and/or oxidizer and/or coolant to the fuel cell elements and/or for discharging fuel and/or oxidizer and/or exhaust gas and/or coolant from the fuel cell elements is known from DE 10 2017 212 091 A1. The fluid conduction unit comprises a main body. This comprises multiple fluid lines and connection points for connecting supply lines and/or discharge lines and/or additional components of the fuel cell device.

In many fuel cell stacks, water is formed from hydrogen (H₂) and oxygen (O₂). Water also arises as a product of the electrochemical conversion in fuel cell devices which are operated using other fuels, such as methanol.

In addition, different amounts of water are generally introduced into a fuel cell device by the supplied air.

It is necessary to discharge the water arising, since a fuel cell stack is otherwise flooded and the fuel cell operation is thus disturbed or interrupted.

It is known that the water present in the fuel cell device can result in problems when starting a vehicle in particular at very low temperatures. Liquid accumulations in the line system of fuel cell devices can also result in problems in running operation. Depending on the operating status of a fuel-cell-operated vehicle, variations in the water content of the fluids supplied in the fuel cell stack (for example hydrogen and air) can occur. Continuous operation of the fuel cell device under optimum conditions is thus made more difficult.

### SUMMARY OF THE INVENTION

The present invention is based on the object of providing devices and a method for a motor vehicle driven at least partially by a fuel cell device, by which efficient operation of the motor vehicle is made possible with little expenditure.

This object is achieved according to the invention by a sensor unit as claimed in the independent claim in this regard.

The sensor unit can preferably be a sensor unit for a fluid conduction unit used for discharging liquid.

The fluid conduction unit can be a media distribution unit.

Media distribution units can form component parts of fuel cell devices. They can be used, for example, to conduct fuel and/or oxidizer and/or coolant to the fuel cell elements or can be used to discharge fuel and/or oxidizer and/or exhaust gas and/or coolant from the fuel cell elements.

The fluid conduction unit can preferably be a liquid separating unit or comprise a liquid separating unit.

Liquid in the context of the invention in particular designates an aqueous liquid.

The sensor unit can be, for example, a sensor unit for a fluid conduction unit used for discharging liquid from a fuel cell device.

The sensor unit comprises at least one liquid level detection zone.

Any zone, using which a liquid level can be detected, comes into consideration as a liquid level detection zone. Zones, using which a liquid level can be detected, are known to those skilled in the art.

A level of a liquid can be detected in the liquid level detection zone, for example, in that a signal is emitted at a specific liquid level or upon exceeding or falling below a specific liquid level. For example, the liquid level can be detected in that the liquid itself is detected in the detection zone. The liquid level detection zone can then be a liquid detection zone.

A level of the liquid can be detected in the liquid level detection zone, for example, by the contact with a float, wherein the float rises with rising liquid level and sinks with sinking liquid level. The contact with the float can only be detectable, for example, at a specific liquid level or only above or below a specific liquid level.

The sensor unit can preferably comprise at least one deflection recognition unit for recognizing at least one deflection force, which can act on a liquid collectible at the liquid level detection zone, or for recognizing an effect of the at least one deflection force.

The deflection recognition unit can be a deflection recognition unit which is suitable for recognizing at least one deflection force which can act on a liquid collectible at the liquid level detection zone.

Greatly differing forces come into consideration as a deflection force which can act on a liquid collectible at the liquid level detection zone. A deflection force acting on a liquid collectible at the liquid level detection zone can occur, for example, upon braking or acceleration of a motor vehicle comprising the sensor unit. A deflection force acting on a liquid collectible at the liquid level detection zone can be, for example, a centrifugal force which occurs upon cornering of a motor vehicle comprising the sensor unit. A deflection force acting on a liquid collectible at the liquid level detection zone can be, for example, the force of gravity when a motor vehicle comprising the sensor unit is inclined forward, to the rear and/or to one of the sides.

The deflection recognition unit can preferably be a deflection recognition unit for recognizing an effect of the at least one deflection force. An effect of the at least one deflection force can be, for example, a rise of the liquid level at one point and a drop of the liquid level at another point. An effect of the at least one deflection force can be a variation of the liquid level at at least one point. Those skilled in the art can see that such effects can occur if one of the mentioned deflection forces can act on a liquid detectable at the liquid level detection zone, for example upon acceleration or braking, upon cornering or upon an inclination of a motor vehicle.

One effect of a deflection force can be, for example, a change of a level of the liquid at the liquid level detection zone. A change of the level of the liquid at the liquid level detection zone can occur, for example, upon acceleration, deceleration or inclination of a motor vehicle.

The at least one liquid level detection zone can be designed and configured to generate at least one first liquid level detection signal.

The deflection recognition unit can be designed and configured to generate at least one deflection recognition signal. The deflection recognition signal can be, for example, a second liquid level detection signal or an acceleration signal or an inclination signal.

It can be advantageous if the at least one deflection recognition unit comprises an acceleration sensor and/or an inclination sensor.

The deflection recognition unit can comprise an acceleration sensor. Alternatively or additionally, the deflection recognition unit can comprise an inclination sensor.

The acceleration sensor can be designed and configured to detect an acceleration or a deceleration of a motor vehicle which can comprise the sensor unit.

The acceleration sensor can be designed and configured to detect an acceleration of a motor vehicle, which can comprise the sensor unit, in at least one first spatial direction. The acceleration sensor can preferably be designed and configured to detect an acceleration of a motor vehicle, which can comprise the sensor unit, in a first spatial direction and in a second spatial direction, which differs from the first spatial direction. This can have the effect that both a deflection force, which acts in a first spatial direction and can be caused, for example, by an acceleration or a deceleration, and also a second deflection force, which acts in a second spatial direction and can be caused by cornering, can be detected by the acceleration sensor.

The inclination sensor can be designed and configured to detect an inclination of a motor vehicle which can comprise the sensor unit.

The inclination sensor can be designed and configured to detect an inclination of a motor vehicle, which can comprise the sensor unit, in at least one first spatial direction. The inclination sensor can preferably be designed and configured to detect an inclination of a motor vehicle, which can comprise the sensor unit, in a first spatial direction and in a second spatial direction, which differs from the first spatial direction. This can have the effect that both a deflection force, which acts in a first spatial direction and can be caused, for example, by an acceleration or a deceleration, and also a second deflection force, which acts in a second spatial direction and can be caused by cornering, can be detected by the inclination sensor.

It can be particularly advantageous if the sensor unit, for example the deflection recognition unit, is designed and configured so that at least one first deflection recognition signal can be generated when a deflection force acts, and at least one second deflection recognition signal can be generated when a second deflection force acts.

The first deflection recognition signal is preferably different from the second deflection recognition signal.

The first deflection recognition signal can differ from the second deflection recognition signal, for example, in that the first deflection recognition signal can be output by the sensor unit at a different point, for example at a different electrical conductor or at a different interface, than the second deflection recognition signal.

The second deflection recognition signal can preferably be generated when the second deflection force acts in a different direction than the deflection force, wherein the second deflection force can act opposite or obliquely to the first deflection force. Obliquely to the first deflection force can mean in particular that the second deflection force acts at an angle to the first deflection force which is different from 0° and 180° and which can preferably be 20° to 160°, for example 40° to 140°.

The at least one deflection recognition unit can advantageously comprise multiple liquid level detection zones spaced apart from one another.

The at least one liquid level detection zone can preferably form at least one of the multiple liquid level detection zones which are spaced apart from one another and are comprised by the deflection recognition unit.

It is thus possible in conjunction with the invention that the at least one liquid level detection zone is used for detecting a liquid level and at the same time forms at least one of the multiple liquid level detection zones which are spaced apart from one another and are comprised by the deflection recognition unit.

In particular, the at least one liquid level detection zone can then be designed and configured to generate the at least one first liquid level detection signal and moreover can contribute to generating at least one deflection recognition signal.

It can be particularly advantageous if the at least one deflection recognition unit comprises multiple liquid level detection zones spaced apart from one another in a first direction and multiple liquid level detection zones spaced apart from one another in a second direction.

The at least one liquid level detection zone can preferably form at least one of the multiple liquid level detection zones spaced apart from one another in a first direction here. Alternatively or additionally, the at least one liquid level detection zone can preferably form at least one of the multiple liquid level detection zones spaced apart from one another in a second direction here.

This can enable the effect of a first deflection force to be recognized in that the liquid level extends up to the two liquid level detection zones spaced apart in the first direction. This can moreover enable the effect of a second deflection force to be recognized in that the liquid level extends up to the liquid level detection zones spaced apart from one another in the second direction.

If the at least one deflection recognition unit comprises multiple liquid level detection zones spaced apart from one another in a first direction and multiple liquid level detection zones spaced apart from one another in a second direction, the first and the second direction can assume an angle to one another of 10 to 170°, advantageously of 20 to 160°, in particular of 30 to 150°, preferably of 45 to 135°, particularly preferably of 55 to 125°, very particularly preferably of 65 to 115°, for example of 70 to 110°.

This can be advantageous since it is then possible to distinguish in a particularly simple manner between various deflection forces and this can in each case be taken into consideration in the assessment of a liquid level which can be detected at the at least one liquid level detection zone.

If multiple liquid level detection zones spaced apart from one another in a first direction and multiple liquid level detection zones spaced apart from one another in a second direction are present, one of the liquid level detection zones can be arranged farther down in a liquid collection zone of a fluid conduction unit than the other liquid level detection zones. Preferably, the at least one liquid level detection zone comprised by the sensor unit can be a liquid level detection zone arrangeable lying lowest in a liquid collection zone if multiple liquid level detection zones spaced apart from one another in a first direction and multiple liquid level detection zones spaced apart from one another in a second direction are present.

The at least one liquid level detection zone arrangeable lowest is then preferably at least one of the multiple liquid level detection zones spaced apart from one another in the first direction and one of the multiple liquid level detection zones spaced apart from one another in the second direction.

Specific deflection recognition units according to the invention can additionally comprise multiple liquid level detection zones spaced apart from one another in a third direction. The third direction preferably extends out of a plane within which the two other directions lie. The two directions are preferably the first and the second direction, in which liquid level detection zones are spaced apart from one another.

It can be particularly advantageous if the sensor unit comprises or is a sensor device.

It can be very particularly advantageous if the sensor unit comprises or is a sensor device, wherein at least a part of the multiple liquid level detection zones spaced apart from one another are liquid level detection zones formed at a sensor surface of the sensor device.

At least a part of the multiple liquid level detection zones spaced apart from one another can be liquid detection zones.

Preferably, at least three of the multiple liquid detection zones spaced apart from one another can be sensor zones of the sensor device. The at least three of the multiple liquid detection zones spaced apart from one another can be sensor zones arranged at the sensor surface of the sensor device.

Preferably, multiple liquid level detection zones are arranged in relation to one another at the sensor surface of the sensor device so that the collecting liquid is first detectable via a first liquid level detection zone when the liquid level of a liquid collecting in a liquid collection zone rises and the collecting liquid is detectable later via a second liquid level detection zone when the liquid level of the collecting liquid rises further.

It can be particularly advantageous if a sensor matrix is formed at a sensor surface. The sensor matrix can preferably comprise multiple sensor rows and multiple sensor columns, wherein liquid level detection zones arranged within the sensor rows and sensor columns are spaced apart from one another.

The sensor matrix can advantageously comprise at least two sensor columns and at least two sensor rows. For example, two liquid level detection zones arranged in a sensor row can be spaced apart from one another in a first direction and two liquid level detection zones arranged in a sensor column can be spaced apart from one another in a second direction.

The object is achieved according to the invention by a fluid conduction unit as claimed in the independent claim in this regard.

The fluid conduction unit is a fluid conduction unit for discharging liquid. There is the necessity in many technical fields for discharging liquids in a controlled manner from liquid-conducting vessels and lines.

The fluid conduction unit is preferably a fluid conduction unit for discharging liquid from a fuel cell device. It was emphasized herein at another point that aqueous liquids arise in fuel cell devices. These have to be discharged in a controlled manner from fuel cell devices.

The fluid conduction unit comprises a liquid collection zone and at least one liquid level detection zone arranged in the liquid collection zone. A level of a liquid which is collectible in the liquid collection zone is detectable at the at least one liquid level detection zone.

Preferably, the liquid level detection zone arranged in the liquid collection zone is a liquid level detection zone of a sensor unit according to the invention described herein. Alternatively or additionally, the at least one liquid level detection zone arranged in the liquid collection zone can enable a detection and differentiation of a plurality, advantageously at least three, for example at least four, different liquid levels in the liquid collection zone.

A detection and differentiation of the plurality of different liquid levels in the liquid collection zone can be enabled, for example, in that a different liquid level detection signal is generated or can be generated for each of the plurality of different liquid levels.

If the at least one liquid level detection zone arranged in the liquid collection zone can enable a detection of the plurality of different liquid levels in the liquid collection zone, a deflection recognition unit for recognizing at least one deflection force, which can act on a liquid collectible at the liquid level detection zone, or for recognizing an effect of the at least one deflection force can be superfluous.

The detection of the plurality of different liquid levels in the liquid collection zone can be enabled by a sensor which extends rising in the liquid collection zone. The sensor can extend, for example, rising from a bottom or a wall. The sensor can have multiple switching points for detecting the plurality of different liquid levels in the liquid collection zone. Preferably, each of the switching points corresponds to one liquid level. The plurality of the switching points and the corresponding liquid levels can be of arbitrary sizes. This can enable a continuous or nearly continuous measurement of the liquid level even with varying liquid level.

The fluid conduction unit can preferably comprise a sensor device described herein. The multiple liquid level detection zones spaced apart from one another can be arranged inside the liquid collection zone.

It can be advantageous if the multiple liquid level detection zones spaced apart from one another are sensor zones of the sensor device arranged inside the liquid collection zone.

The fluid conduction unit preferably comprises at least two liquid level detection zones arranged in the liquid collection zone. Preferably, the two liquid level detection zones inside the liquid collection zone are spaced apart from one another in a first direction. It can be advantageous if one of the two liquid level detection zones lies farther down inside the liquid collection zone than the other liquid level detection zone.

Preferably, the first direction, in which the two liquid level detection zones are spaced apart inside the liquid collection zone, differs from a direction in which the liquid level rises when the liquid collection zone fills with a liquid. In the determination of the direction in which the liquid collection zone fills with the liquid, an arrangement, as intended, of the fluid conduction unit on the fuel cell device and a motor vehicle, which stands flat and in which the fuel cell device is arranged, are assumed.

The at least one liquid level detection zone arranged in the liquid collection zone can advantageously be a liquid level detection zone of a sensor unit according to the invention described herein or be a liquid level detection zone of a sensor device according to the invention described herein.

It can be particularly preferable if the sensor unit comprises an inner section and an outer section. The inner section can be arranged in the liquid collection zone. The outer section can be arranged outside the liquid collection zone. The inner section can advantageously extend into the liquid collection zone. The outer section can advantageously be arranged outside a wall of the fluid conduction unit delimiting the liquid collection zone.

It can be particularly advantageous if the inner section of the sensor unit extends obliquely into the liquid collection zone. If the inner section of the sensor unit extends obliquely into the liquid collection zone, this can mean in particular that a main extension direction of the inner section of the sensor unit assumes an angle in relation to a direction along which the liquid can rise in the liquid collection zone, which is greater than 0° and at the same time is less than 90°. This angle can preferably be in the range of 10° to 80°, particularly preferably in the range of 20° to 70°, very particularly preferably in the range of 25° to 65°. This can mean in particular that a liquid rising in the liquid collection zone initially covers a first area of the inner section and that as the liquid rising in the liquid collection zone rises further, a further area of the inner section is covered by the liquid.

It can be particularly advantageous if a sensor matrix described herein is arranged on the inner section of the sensor unit extending obliquely in the liquid collection zone. The sensor matrix can be arranged, for example, on a sensor surface of the inner section of the sensor unit extending obliquely in the liquid collection zone. In particular, the sensor unit can then be a sensor device described herein.

The first direction, in which multiple liquid level detection zones are spaced apart from one another, can be aligned orthogonally to the main extension direction of the inner section of the sensor unit, for example. The second direction, in which multiple liquid level detection zones are spaced apart from one another, can be aligned parallel to the main extension direction of the inner section of the sensor unit, for example.

The fluid conduction unit can comprise a sensor receptacle zone in which the sensor unit is received. The sensor unit can preferably be received in the sensor receptacle zone so that the inner section of the sensor unit comes to rest in the liquid collection zone and the outer section of the sensor unit comes to rest outside the liquid collection zone.

It can be particularly advantageous if the sensor receptacle zone is formed on a wall of the fluid conduction unit which delimits the liquid collection zone at the bottom and to the side. This can promote a desired inclined orientation of an inner section of the sensor unit and at the same time enable a particularly space-saving arrangement of an outer section of the sensor unit, which occupies essentially no additional installation space below the liquid collection zone.

It can be particularly advantageous if the fluid conduction unit comprises a controllable discharge valve for discharging liquid which is collectible in the liquid collection zone. The controllable discharge valve can advantageously be designed and configured so that it can receive a signal. The signal can be, for example, a signal which can be emitted by a control system described herein. The signal can be, for example, a signal to open the discharge valve or to close the discharge valve.

It can be particularly advantageous if a direct or an indirect connection of the at least one liquid level detection zone arranged in the liquid collection zone to the controllable discharge valve exists or can be established. The connection can be a connection for the direct or indirect transmission of a liquid level detection signal that can be generated by the at least one liquid level detection zone to the discharge valve. The indirect connection can be established or able to be established via a control system, which is described herein and can be, for example, a control unit or a controller.

It can be preferred if the fluid conduction unit comprises a flow barrier. The flow barrier can be formed in the liquid collection zone. It can preferably counteract a displacement of liquid collectible in the liquid collection zone. It can be particularly advantageous if the flow barrier can counteract a displacement, induced by the deflection force, of liquid collectible in the liquid collection zone. This can in particular have the effect that a displacement of liquid which has collected in the liquid collection zone does not take place or does not take place into a fuel cell stack. This can also enable more efficient operation of a motor vehicle with particularly little expenditure.

In addition, a more reliable, less location-dependent detection of the level of a liquid in the liquid level detection zone can thus be enabled.

The fluid conduction unit can preferably comprise a purge line. A purge line can be understood, for example, as a flushing line, which can be used to entirely or completely dispense a liquid residue by means of a gas flow that can be conducted through the purge line from the fluid conduction unit described herein or fuel cell device.

The purge line can preferably extend from a lower-lying area of the liquid collection zone into a higher-lying area of the liquid collection zone.

The purge line can preferably be tubular.

The purge line can open into a liquid dispensing opening through which a liquid residue can be able to be entirely or completely dispensed. A dispensing valve receptacle zone can be formed at the liquid dispensing opening. A dispensing valve can be attached or attachable at the dispensing valve receptacle zone.

The fluid conduction unit can comprise a plastic component. The plastic component can be, for example, a base element in which the liquid collection zone is formed.

The plastic component can be a component obtained by molding, for example by injection molding or by shaping.

The purge line can preferably extend along a dispensing direction. The dispensing direction can be oriented parallel to a demolding direction. The demolding direction is the direction along which the plastic component comprised by the fluid conduction unit has been removed from a molding tool.

In this context, parallel can in particular mean that the demolding direction and the dispensing direction assume an angle in relation to one another of 20° or less, preferably 10° or less, for example 5° or less.

The fluid conduction unit can preferably have a sealing zone. The sealing zone can be formed, for example, on the fluid conduction unit itself or on the base element in which the liquid collection zone is formed.

The sealing zone can comprise a flange zone formed on an edge of the fluid conduction unit or on an edge of the base element.

The sealing zone can have a depression. The depression can preferably extend along the sealing zone and can be formed, for example, at the flange zone. The depression is preferably used to accommodate a sealing element.

The object is achieved according to the invention by a fuel cell device as claimed in the independent claim in this regard.

The fuel cell device can in particular be a fuel cell device for a motor vehicle. The motor vehicle can in particular be a motor vehicle completely or partially driven by the fuel cell device.

The fuel cell device comprises a fluid conduction unit. The fluid conduction unit can be, for example, a fluid conduction unit according to the invention described herein.

The discharge of liquid collecting in a liquid collection zone of the fuel cell device, for example in the liquid collection zone of the fluid conduction unit according to the invention described herein, or of liquid collectible therein takes place through a controllable discharge valve.

The discharge valve is controlled according to a detection of a liquid at at least one liquid level detection zone arranged in the liquid collection zone and/or a recognition of at least one deflection force, which can act on a liquid collectible at the liquid level detection zone, or a recognition of an effect of the at least one deflection force.

The discharge valve can thus in particular be controlled according to the detection of the liquid. Alternatively or additionally, the discharge valve can in particular be controlled according to the recognition of the at least one deflection force or the recognition of the effect of the at least one deflection force.

The specification that the mentioned detection or the mentioned recognition is decisive for the control of the discharge valve does not preclude that the detection and/or the recognition is detected and processed by a control system, for example by a control system described herein.

The discharge valve can thus in particular be indirectly controlled according to the mentioned detection and/or the mentioned recognition.

In addition, further data and/or information and/or signals can be decisive for the control of the discharge valve. The further data and/or information and/or signals can in particular comprise a pressure and/or a temperature.

It can be preferred if the fuel cell device comprises a control system or is connected to a control system. The control system can preferably be connected or connectable to a sensor unit, for example to a sensor unit according to the invention described herein. The control system can advantageously be a control system according to the invention described herein. In particular if the fuel cell device is connected to a control system which is not comprised by the fuel cell device, the control system can be a control system of a motor vehicle, which additionally performs further control tasks.

The discharge valve can be completely or partially controllable or controlled by the control system.

The object is achieved according to the invention by a method for controlling a discharge valve as claimed in the independent claim in this regard.

The method for controlling a discharge valve is in particular a method for controlling a discharge valve for discharging liquid from a liquid collection zone.

The liquid collection zone is preferably a liquid collection zone of a fluid conduction unit, for example a fluid conduction unit according to the invention described herein.

The fluid conduction unit is preferably a fluid conduction unit of a fuel cell device. The fuel cell device can preferably be a fuel cell device according to the invention described herein.

The fuel cell device is preferably a fuel cell device of a motor vehicle according to the invention described herein.

The discharge valve is controlled according to at least one liquid level detection signal and/or at least one deflection recognition signal.

The discharge valve can be controlled in particular according to at least one liquid level detection signal. Alternatively or additionally, the discharge valve can be controlled according to at least one deflection recognition signal.

The at least one liquid level detection signal can preferably originate from at least one liquid level detection zone arranged in the liquid collection zone. It can be advantageous in particular if the at least one liquid level detection signal originates from at least one liquid level detection zone which is arranged in the liquid collection zone and is associated with a sensor unit or sensor device according to the invention described herein.

The at least one deflection recognition signal can preferably originate from at least one deflection recognition unit. The at least one deflection recognition signal can moreover preferably stem from the recognition of a deflection force which acts on a liquid collectible at the at least one liquid level detection zone, and/or the recognition of an effect of this deflection force. The at least one deflection recognition signal can preferably stem from the recognition of a deflection force which acts on a liquid collectible at the at least one liquid level detection zone. Alternatively or additionally, the at least one deflection recognition signal can preferably stem from the recognition of an effect of this deflection force.

It can be particularly advantageous if the at least one deflection recognition signal originates from at least one deflection recognition unit of a sensor unit or sensor device according to the invention described herein.

In conjunction with the method according to the invention, the specification that the discharge valve is controlled according to the at least one liquid level detection signal and/or the at least one deflection recognition signal, does not also mean that further signals which are distinguished from the above-mentioned signals would have to remain unconsidered in the control of the discharge valve.

The method can in particular be a method for preventing flooding of a fuel cell stack with the liquid collectible in the liquid collection zone.

It can be particularly advantageous if the discharge valve is controlled according to the at least one liquid level detection signal and the at least one deflection recognition signal.

If the discharge valve is controlled according to the at least one liquid level detection signal and/or the at least one deflection recognition signal, the control can particularly advantageously take place so that the discharge valve is only transferred into an open state when
a liquid in the liquid collection zone has risen up to a liquid level detection zone arranged farthest down in the liquid collection zone and a liquid level detection signal originates from the liquid level detection zone and
the liquid collected in the liquid collection zone reaches at least one of multiple liquid level detection zones arranged farther up in the liquid collection zone, which are spaced apart in different directions from the liquid level detection zone arranged farthest down in the liquid collection zone.

The deflection recognition signal can in particular be a second liquid level detection signal originating from at least one of the liquid level detection zones arranged farther up in the liquid collection zone.

It can be particularly advantageous if the discharge valve is additionally controlled according to a pressure prevailing in the liquid collection zone. The discharge valve can additionally be controlled here, for example, according to a difference between the pressure prevailing in the liquid collection zone and an ambient pressure.

The pressure prevailing in the liquid collection zone can advantageously be determined or determinable using a pressure sensor.

The pressure prevailing in the liquid collection zone can be determined directly or indirectly using the pressure sensor or can be determinable directly or indirectly using the pressure sensor.

The pressure sensor can be arranged in the liquid collection zone. In particular, the pressure prevailing in the liquid collection zone can then be determined directly using the pressure sensor or can be determinable directly using the pressure sensor. A pressure determined by the pressure sensor then corresponds to the pressure prevailing in the liquid collection zone.

The pressure sensor can be arranged in a fuel cell device, in particular in the fuel cell device described herein, in a zone that lies outside the liquid collection zone and has a gas-conducting connection to the liquid collection zone. The pressure prevailing in the liquid collection zone can then be determined indirectly using the pressure sensor or can be determinable indirectly using the pressure sensor, wherein additionally a pressure gradient which results across the gas-conducting connection can be taken into consideration.

The fuel cell device can preferably comprise a fuel cell stack. The zone, which lies outside the liquid collection zone and in which the pressure sensor can be arranged, can preferably be a stack inlet zone. The stack inlet zone can preferably have a gas-conducting connection to the liquid collection zone via one or more cells of the fuel cell stack. An anode gas can preferably be conducted or able to be conducted via the stack inlet zone through the one or more cells into the liquid collection zone. The pressure prevailing in the liquid collection zone can then be determined indirectly using the pressure sensor or can be determinable indirectly using the pressure sensor, wherein preferably the pressure gradient which results across the one or more cells can additionally be taken into consideration.

The pressure gradient can be an empirically determined pressure gradient. The empirically determined pressure gradient can be a pressure gradient which is empirically determined in the development phase of a fuel cell device.

A further pressure sensor in the liquid collection zone can thus be omitted.

The pressure gradient, for example the empirically determined pressure gradient, can be applied in the controller.

The pressure gradient, for example the empirically determined pressure gradient, can be taken into consideration, for example, in the determination of the pressure prevailing in the liquid collection zone if the discharge valve is additionally controlled according to a pressure prevailing in the liquid collection zone.

The ambient pressure can advantageously be determined using a pressure sensor which is arranged at a point that is not spatially separated from the surrounding atmosphere.

It can be particularly advantageous if a duration of an opening interval in which the discharge valve adopts an open state is controlled according to
the at least one liquid level detection signal and/or the at least one deflection recognition signal and/or
the pressure prevailing in the liquid collection zone.

For example, the duration of an opening interval in which the discharge valve adopts an open state can be controlled according to
the at least one liquid level detection signal and the at least one deflection recognition signal and
the pressure prevailing in the liquid collection zone.

This offers the additional advantage that the pressure, which prevails in the liquid collection zone and decisively influences a discharge speed of the liquid dischargeable through the discharge valve, can also be taken into consideration when establishing the duration of an opening interval. It is thus possible to prevent the discharge valve from still remaining open even after a discharge of the collected liquid. In this way, an undesired escape of valuable fuel, for example of hydrogen, can be substantially avoided. Ultimately, this also promotes efficient operation of a motor vehicle with little expenditure.

It can be advantageous if the discharge valve is controlled according to fill levels which are reached in the liquid collection zone. For example, the discharge valve can be opened when an upper fill level threshold value is reached and/or the discharge valve can be closed when a lower fill level threshold value is reached.

Opening of the discharge valve can preferably take place
when a signal, decisive for the opening, for example of the at least one liquid level detection signal and/or of the at least one deflection recognition signal, has been detected within a predetermined period of time with a minimum frequency decisive for the opening or in a minimum duration decisive for the opening and/or
when a fill level threshold value decisive for the opening has been reached or exceeded within a predetermined period of time with a minimum frequency or for a minimum duration.

Closing of the discharge valve can preferably take place
when a signal, decisive for the closing, for example of the at least one liquid level detection signal and/or of the at least one deflection recognition signal, has not been detected within a predetermined period of time with a minimum frequency decisive for the closing or has not been detected in a minimum duration decisive for the closing and/or
when a fill level threshold value decisive for the closing has been fallen below within a predetermined period of time with a minimum frequency or for a minimum duration.

Alternatively, the discharge valve can be opened when an upper fill level threshold value is reached, and/or the discharge valve can be closed after the discharge valve has been kept open for a predetermined time.

A desired degree of emptying can thus be ensured.

For example, the method can be controlled so that complete emptying takes place or a lower liquid residue remains in the liquid collection area when a motor vehicle, for example the motor vehicle described herein, is transferred into an idle state, for example into a parking position, and that a partial emptying takes place or a greater liquid residue remains in the liquid collection area when the motor vehicle is in a driving-ready operating state. In this way, advantages can result for the cold start behavior in winter if no or only very little remaining liquid (water) can freeze in the parked motor vehicle and cause starting problems. It is thus possible to substantially prevent liquid from remaining in the vehicle.

In addition, the method can be controlled so that a partial emptying also takes place or a greater liquid residue also remains in the liquid collection area when the motor vehicle is transferred within a building into the idle state, for example into the parking position. In this way, the operational safety can be further increased, since an escape of fuel, for example hydrogen, can be prevented efficiently and completely in particular also when parking within buildings.

In particular the operational safety can thus advantageously be increased still further. This is because an escape of fuel, for example hydrogen, which can form combustible mixtures with surrounding oxygen (oxyhydrogen), can be reliably prevented according to the invention in a particularly simple manner and in particular within buildings without having to accept a negative effect on the cold start behavior of the motor vehicle parked in the open air.

It can be particularly advantageous if in the method the control valve is closed before a gas flows out of the liquid collection zone through the discharge valve.

The object is achieved according to the invention by a method for controlling a fuel cell device as claimed in the independent claim in this regard.

The method for controlling a fuel cell device is, for example, a method for controlling a fuel cell device described herein.

The fuel cell device is controlled in the method for controlling a fuel cell device according to
at least one liquid level detection signal, which can preferably originate from at least one liquid level detection zone arranged in the liquid collection zone, and/or
at least one deflection recognition signal, which can preferably originate from at least one deflection recognition unit and can preferably stem from:
   the recognition of a deflection force which acts on a liquid collectible at the at least one liquid level detection zone and/or
   the recognition of an effect of this deflection force,
      wherein the fuel cell device is transferred from a higher-performance into a lower-performance operating state or into a switched-off state when
the at least one liquid level detection signal indicates reaching or exceeding a fill level threshold value in the liquid collection zone and/or
the at least one deflection recognition signal indicates reaching or exceeding a deflection force threshold value of the deflection force or indicates an effect of the at least one deflection force which indicates reaching or exceeding the deflection force threshold value.

The fuel cell device can preferably be transferred from a higher-performance into a lower-performance operating state or into a switched-off state when an inclination by at least 20°, preferably at least 25°, for example at least 30°, can be concluded from the deflection recognition signal.

The inclination specified here relates to a non-inclined state which a four-wheeled motor vehicle and a fuel cell device arranged therein adopt, for example, when the motor vehicle is stopped with all four wheels on a level road.

The method for controlling the discharge valve can particularly advantageously at the same time be a method for controlling the fuel cell device having the features specified herein for the method for controlling the fuel cell device.

The fuel cell device can preferably be transferred from a higher-performance into a lower-performance operating state or into a switched-off state when an inclination by at least 20°, preferably at least 25°, for example at least 30°, can be concluded from the deflection recognition signal and opening of the discharge valve can take place when a lesser inclination can be concluded from the deflection recognition signal.

The object is achieved according to the invention by a control system, for example by a control unit, as claimed in the independent claim in this regard.

The control system can be, for example, a control unit. The control unit can be a controller.

Many different types of control systems, which can comprise one or more control units, for example controllers, are installed in motor vehicles.

The control system, for example the control unit, is designed and configured to control a discharge valve according to the method according to the invention described herein and/or to control a fuel cell device according to the invention described herein.

The control system, for example the control unit, can advantageously comprise an interface for receiving at least one liquid level detection signal and an interface for receiving at least one deflection recognition signal. Moreover, the control system can comprise an interface for emitting a signal to the discharge valve and/or an interface for emitting a signal for controlling the operating state of the fuel cell device. The control system can preferably comprise the interface for emitting the signal to the discharge valve and the interface for emitting the signal for controlling the operating state of the fuel cell device.

It can be preferred if the control system, for example the control unit, comprises an interface for receiving at least one signal emitted by a pressure sensor.

The control system, for example the control unit, is also ultimately used to enable more efficient operation of a motor vehicle with the least possible expenditure.

In particular, with the aid of the control system, for example with the aid of the control unit, the discharge valve and in particular its opening and the duration of an opening interval can be optimized based on the liquid level detection signals and deflection recognition signals so that the risk of flooding of a fuel cell stack with accumulated liquid is minimized and at the same time an undesired escape of valuable fuel via the discharge valve is avoided.

The object is achieved according to the invention by a motor vehicle as claimed in the independent claim in this regard. The motor vehicle can in particular be a motor vehicle completely or partially driven by the fuel cell device.

The motor vehicle can be a road vehicle, water vehicle or a rail vehicle.

It can be particularly preferred if the motor vehicle is a road vehicle. In general, stronger inclinations and decelerations and also accelerations occur in road vehicles, so that the advantages which can result due to the invention can be implemented to a particular degree in road vehicles.

In particular, stronger deflection forces and effects of deflection forces can occur in road vehicles than in rail vehicles.

Periodic changes of inclination can occur in water vehicles, in particular. This can be caused, for example, by waves.

This can result in problems in the detection of a high fill level of the liquid collectible in the liquid collection zone.

It has been shown that these problems can be remedied in a particularly simple manner using the invention. This is because just these changes of inclination can be deliberately recognized by the combination of a liquid level detection with a deflection recognition and an optionally excessively high fill level can be concluded therefrom.

The motor vehicle comprises a sensor unit, for example the sensor unit according to the invention described herein, a fuel cell device, for example the fuel cell device according to the invention described herein, and a control system, for example the control system according to the invention described herein, for example the control unit according to the invention described herein.

The sensor unit is connected to the control system so that at least one liquid level detection signal and/or at least one deflection recognition signal is receivable by the control system. The control system is connected to the discharge valve so that a signal emitted by the control system is transmittable to the discharge valve.

The sensor unit is preferably connected to the control system so that at least one liquid level detection signal and at least one deflection recognition signal are receivable by the control system.

In the motor vehicle according to the invention, a sensor of the sensor unit can preferably be a sensor installed in the motor vehicle for other purposes in any case.

The sensor unit comprised by the motor vehicle can advantageously be the sensor unit described herein, in which the at least one deflection recognition unit comprises an acceleration sensor and/or an inclination sensor. A signal generated by the acceleration sensor and/or the inclination sensor, for example the deflection recognition signal, can be used not only to control the discharge valve, for example.

The signal generated by the acceleration sensor and/or the inclination sensor can in particular also be used for the control of a function of the motor vehicle outside the fuel cell device.

Of course, features described in conjunction with subject matter according to the invention can also form features of another subject matter according to the invention described herein. Subjects according to the invention are in this case in particular the sensor unit, the fluid conduction unit, the fuel cell device, the method for controlling a discharge valve and the control system, as well as the motor vehicle. In particular, the sensor unit, the fluid conduction unit, the fuel cell device and also the motor vehicle can be designed and configured so that a discharge valve is controllable according to the method according to the invention described herein thereby.

Further preferred features and/or advantages of the invention are the subject matter of the following description and the illustration in the drawing of exemplary embodiments.

### BRIEF DESCRIPTION OF THE DRAWINGS

FIG. 1: shows a schematic illustration of a detail of a fluid conduction unit;

FIG. 2: shows a further view of the detail of the fluid conduction unit from FIG. 1;

FIG. 3: shows a further view of the detail of the fluid conduction unit from FIG. 1;

FIG. 4: shows a further view of the detail of a fluid conduction unit from FIG. 1;

FIG. 5: shows a further view of the detail of the fluid conduction unit from FIG. 1;

FIG. 6: shows a further view of the detail of the fluid conduction unit from FIG. 1;

FIG. 7: shows section A-A from FIG. 4;

FIG. 8: shows section B-B from FIG. 4;

FIG. 9: shows a schematic illustration of the sensor device of the fluid conduction unit shown in FIGS. 1 to 8;

FIG. 10: shows a detail from FIG. 3;

FIG. 11: shows a view of a further fluid conduction unit;

FIG. 12: shows a further view of the fluid conduction unit from FIG. 11;

FIG. 13: shows a further view of the fluid conduction unit from FIGS. 11 and 12;

FIG. 14: shows section A-A from FIG. 13;

FIG. 15: shows a schematic view of a further fluid conduction unit;

FIG. 16: shows a further view of the further fluid conduction unit from FIG. 15;

FIG. 17: shows a further view of the further fluid conduction unit from FIG. 15;

FIG. 18: shows a further view of the further fluid conduction unit from FIG. 15;

FIG. 19: shows a further view of the further fluid conduction unit from FIG. 15; and

FIG. 20: shows a further view of the further fluid conduction unit from FIG. 15.

Identical or functionally equivalent elements are provided with the same reference signs in all figures.

### DETAILED DESCRIPTION OF THE DRAWINGS

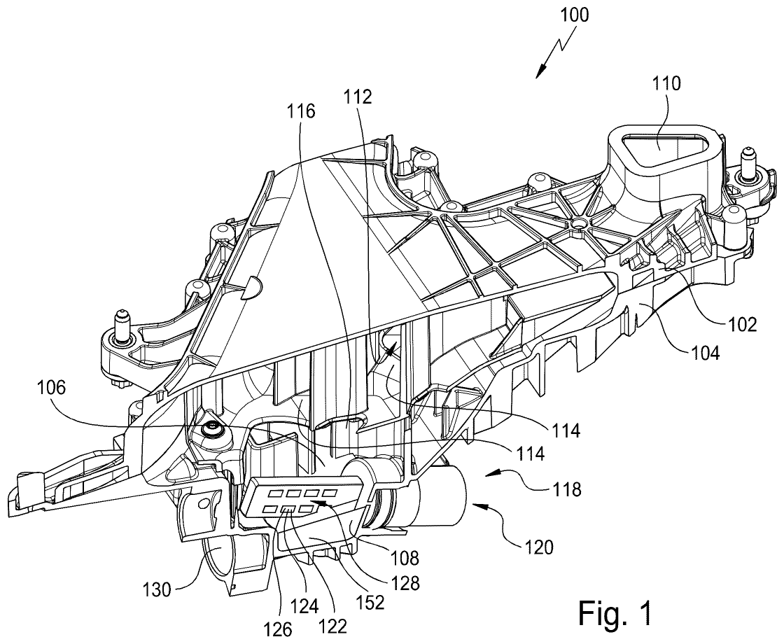

FIGS. 1 to 6 show a detail of a fluid conduction unit 100 from various perspectives.

The fluid conduction unit shown can be used to discharge liquid from a fuel cell device.

The fluid conduction unit 100 comprises a cover element 102 and a base element 104. Cover element 102 and base element 104 can be plastic components, for example plastic components obtained by injection molding.

The fluid conduction unit 100 comprises a liquid collection zone 106. In the example shown here, the liquid collection zone 106 is formed in a depression 108 of the base element 104.

The fluid conduction unit 100 comprises a fluid passage 110. In the example shown here, the fluid passage 110 is formed on the cover element 102.

A liquid separation zone 112 is formed in the interior of the fluid conduction unit 100. The fluid passage 110 offers an option for supplying a gas, which can be a hydrogenous gas, for example, to the liquid separation zone 112 or discharging it from the liquid separation zone 112.

Channel zones 114 lead out of the liquid separation zone 112 and open at a liquid passage 116 through which separated liquid can drain into the liquid collection zone 106.

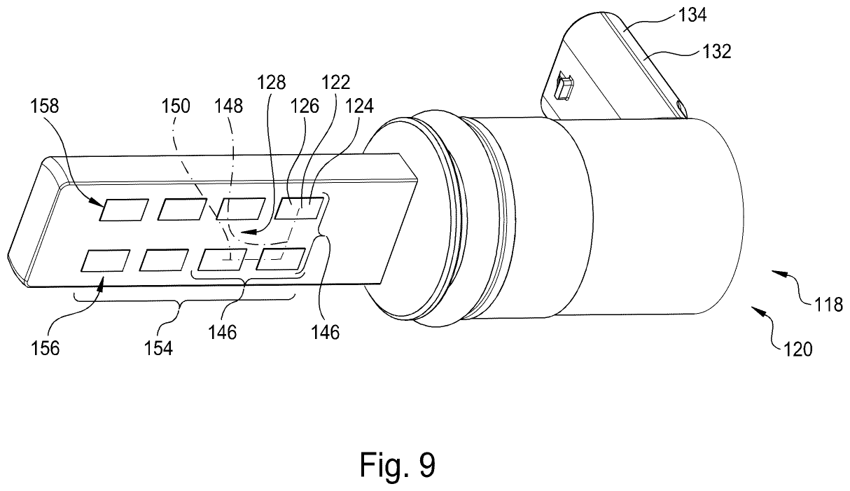

The fluid conduction unit 100 comprises a sensor unit 118. The sensor unit 118 is a sensor device 120, shown in more detail in FIG. 9.

The sensor unit 118 comprises multiple liquid level detection zones 122. The liquid level detection zones 122 are liquid detection zones 124. In this case, these are sensor zones 126 of the sensor device 120.

The liquid level detection zones 122 are arranged at a sensor surface 128 of the sensor device 120.

The fluid conduction unit 100 additionally comprises a valve receptacle zone 130 in which a controllable discharge valve for discharging liquid, which is collectible in the liquid collection zone 106, can be received.

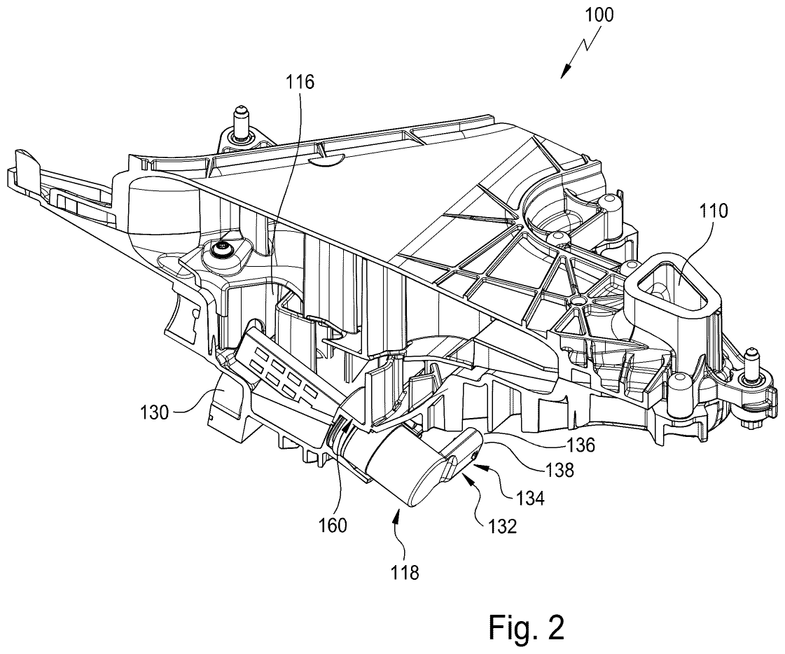

It can be seen clearly in FIG. 2 that the sensor unit 118 comprises a connecting element 132. The connecting element 132 is a receptacle element 134. A plug can be received in the receptacle element 134, for example. The sensor unit 118 can emit a liquid level detection signal 136 and a deflection recognition signal 138 via the connecting element 132. These signals 136 and 138 can be transmitted, for example, to a control system described herein.

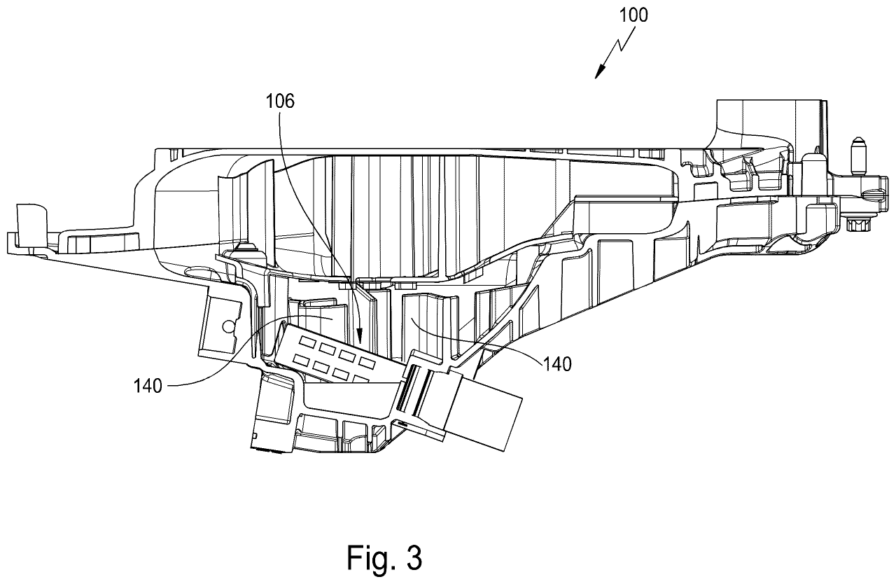

It can be seen clearly in particular from FIG. 3 that the fluid conduction unit 100 comprises flow barriers 140. The flow barriers 140 are arranged in the liquid collection zone 106. They extend from the base element 104 in the demolding direction.

The flow barriers 140 counteract undesired movements of the liquid collecting in the liquid collection zone 106. Even with a relatively high liquid level, a risk that liquid flows back into a fuel cell stack can also be substantially prevented by the flow barriers 140.

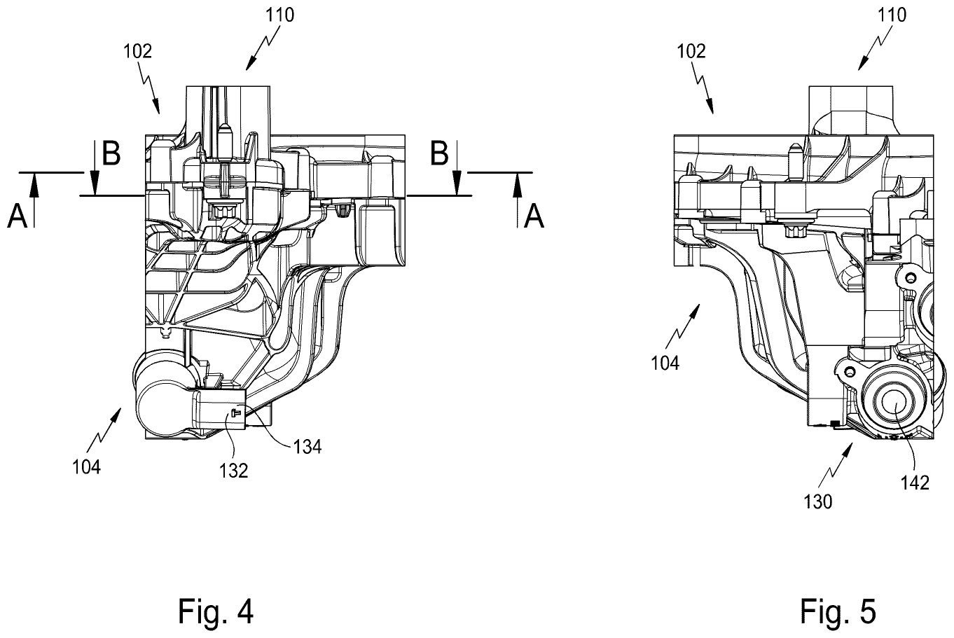

The connecting element 132 described in conjunction with FIG. 2 can also be seen clearly in the perspective shown in FIG. 4.

A liquid passage opening 142 is recognizable in the perspective of the fluid conduction unit 100, shown in FIG. 5. The liquid passage opening 142 is formed at the valve receptacle zone 130.

A liquid collectible in the liquid collection zone 106 can be discharged from the liquid collection zone 106 through the liquid passage opening 142 and the controllable discharge valve, which is also not shown in FIG. 5.

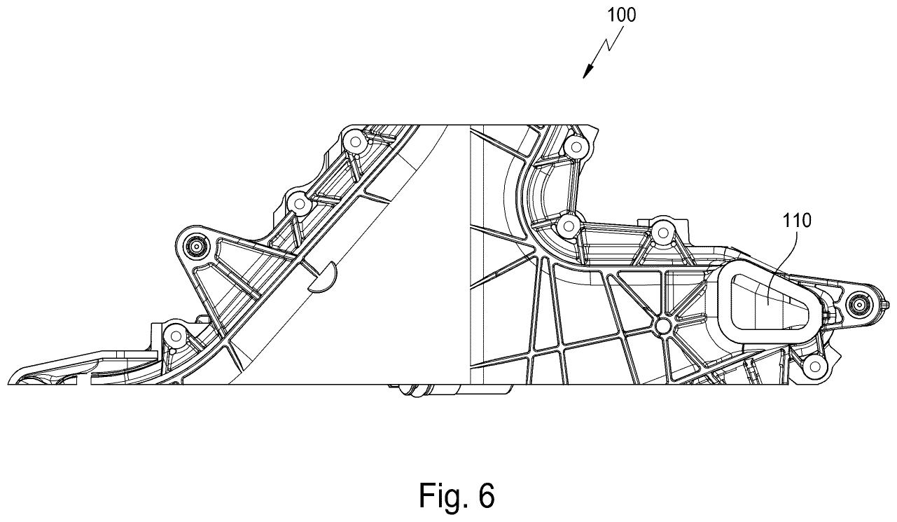

In the perspective shown in FIG. 6, the observer looks through the fluid passage 110 into the interior of the fluid conduction unit 100.

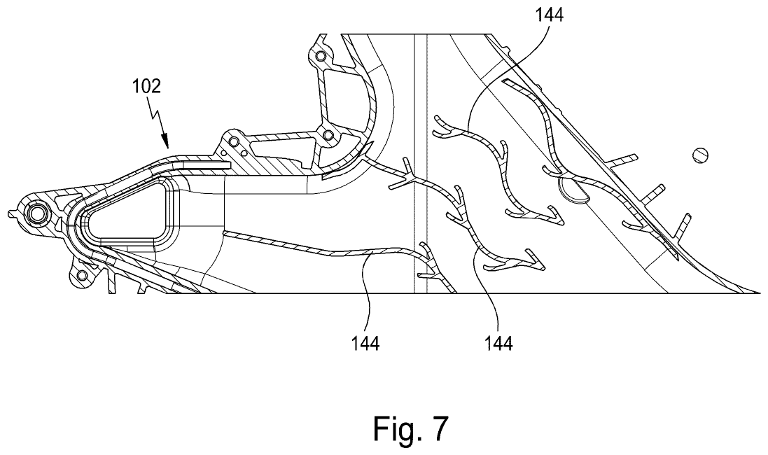

FIG. 7 shows section A-A from FIG. 4. It can be seen clearly from FIG. 7 that the fluid conduction unit comprises channel walls 144. The channel walls 144 delimit the channel zones 114 that can be seen in FIG. 1.

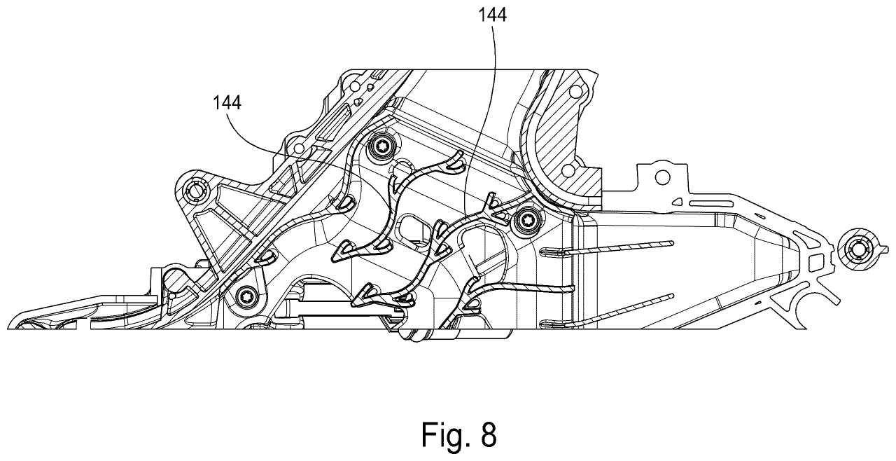

FIG. 8 shows section B-B from FIG. 4. Channel walls 144 can also be seen therein.

FIG. 9 shows the sensor unit 118 already described briefly in conjunction with FIG. 1 in an enlarged perspective view.

The sensor unit 118 is a sensor device 120. At the sensor surface 128, the sensor unit 118 comprises eight liquid level detection zones 122 which are liquid detection zones 124.

The liquid level detection zones 122 are spaced apart from one another. The sensor unit 118 comprises a plurality of detection recognition units 146. The deflection recognition units are used to recognize an effect of a deflection force, which can act on a liquid collectible at the liquid level detection zone.

The effect of this deflection force can be, for example, a change of a level of the liquid at a liquid level detection zone 122. A change of a level at the liquid level detection zone 122 can occur, for example, when a motor vehicle, in which the fluid conduction unit 100 is installed, is inclined. This can occur in particular when driving or parking on or at gradients.

Deflection forces which result in a change of the level of the liquid at a liquid level detection zone can also be acceleration forces which can occur upon an increase or a reduction of the driving speed or when cornering.

FIG. 9 shows two deflection recognition units 146 which each comprise two liquid level detection zones 122 spaced apart from one another. A first deflection recognition unit 146 comprises two liquid level detection zones 122 spaced apart from one another in a first direction 148. The second deflection recognition unit 146 comprises two liquid level detection zones 122 spaced apart from one another in a second direction 150. The first direction 148 differs from the second direction 150.

A liquid level detection zone 122, which comes to rest lowest in the liquid collection zone 106 (FIG. 1), forms one of the two liquid level detection zones 122 spaced apart from one another in the first direction 148 and one of the two liquid level detection zones 122 spaced apart from one another in the second direction 150. Depending on the direction and strength of a deflection force, a liquid 152, which has collected in the liquid collection zone 106, can reach one or more sensor surfaces 128. It is thus conceivable, for example, that on a downhill gradient, the two liquid level detection zones 122 spaced apart in the first direction 148 detect liquid, whereas on a steep uphill slope, the two liquid level detection zones 122 spaced apart in the second direction 150 detect liquid.

This can enable, even entirely without an acceleration sensor or an inclination sensor, an amount of collected liquid 152 to be estimated much more accurately than upon a detection of liquid at a single liquid level detection zone.

The sensor zones 126 are arranged in the form of a sensor matrix 154 at the sensor surface 128. In the example shown, four sensor rows 156 and two sensor columns 158 are provided.

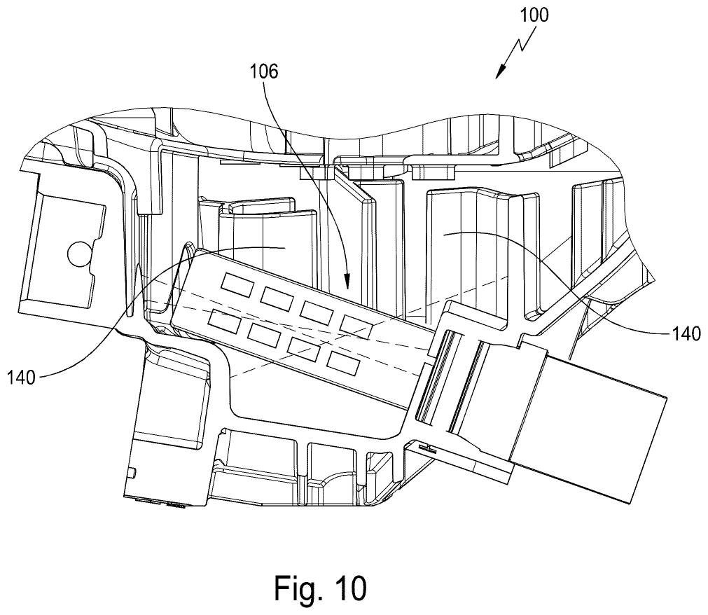

FIG. 10 shows a detail from FIG. 3 and schematically illustrates with three different dashed lines three different exemplarily liquid levels which a liquid in the liquid collection zone 106 can adopt. The liquid levels represent the result of the effects of various deflection forces, which can result, for example, due to braking, deceleration or cornering in vehicles or else due to waves in water vehicles.

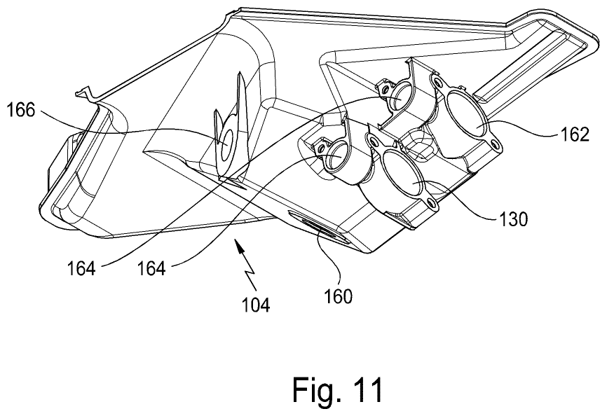

FIG. 11 shows a further embodiment of a fluid conduction unit. This fluid conduction unit comprises a base element 104 and a valve receptacle zone 130. The valve receptacle zone 130 is formed on the base element 104.

A sensor receptacle zone 160 can additionally be seen. A sensor unit 118 or sensor device 120, which is not shown in FIG. 11 in conjunction with the embodiment shown therein, can be received at least partially in the base element 104 by the sensor receptacle zone 160.

In addition to the valve receptacle zone 130, a discharge valve receptacle zone 162 can also be seen in the view shown in FIG. 11. A corresponding connection element 164 is formed in each case at the valve receptacle zone 130 and the discharge valve receptacle zone 162.

A further sensor, for example a temperature sensor or a pressure sensor, can be at least partially inserted into the base element 104 through the further receptacle zone 166 formed on the base element 104.

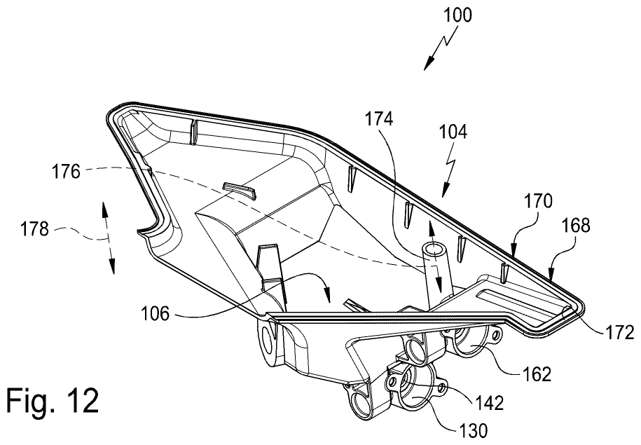

FIG. 12 shows a further representation of the further fluid conduction unit 100 from FIG. 11.

The base element 104 has a sealing zone 168. The sealing zone 168 is designed in the form of a flange zone 170. The sealing zone 168 comprises a circumferential depression 172 in which a sealing element (not shown here) can be received.

The base element 104 comprises a liquid collection zone 106.

A purge line 174 extends out of the liquid collection zone. The purge line 174 extends in the dispensing direction 176. In the example shown here, the purge line 174 is formed tubular. The dispensing direction 176 extends in the direction of the tubular purge line 174.

The dispensing direction 176 coincides with a demolding direction 178. The demolding direction 178 describes the direction of the demolding of the base element 104, which can be removed in a molding process, for example an injection molding process, in the demolding direction 178 from a molding tool which is preferably designed so that the purge line 174 can be formed at the same time.

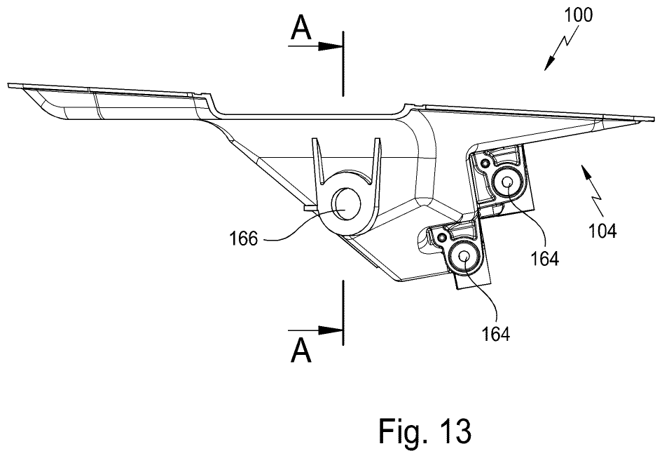

FIG. 13 likewise shows the further fluid conduction unit 100 from FIGS. 11 and 12. In the view shown therein, the receptacle zone 166 can be seen. In addition, the connection elements 164 can also be clearly seen.

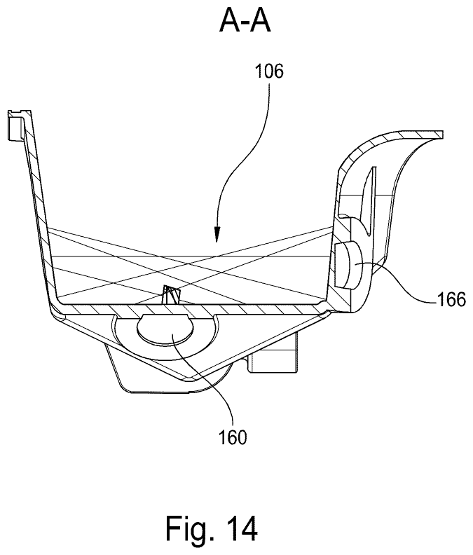

FIG. 14 shows section A-A from FIG. 13. The section is executed through the sensor receptacle zone 160 and through the receptacle zone 166 and exposes the view into the liquid collection zone 106. FIG. 14 schematically illustrates with solid lines exemplary liquid levels which a liquid can adopt in the liquid collection zone 106. The liquid levels represent the result of the effects of various deflection forces, which can result, for example, due to braking, deceleration or cornering in vehicles or else due to waves in water vehicles.

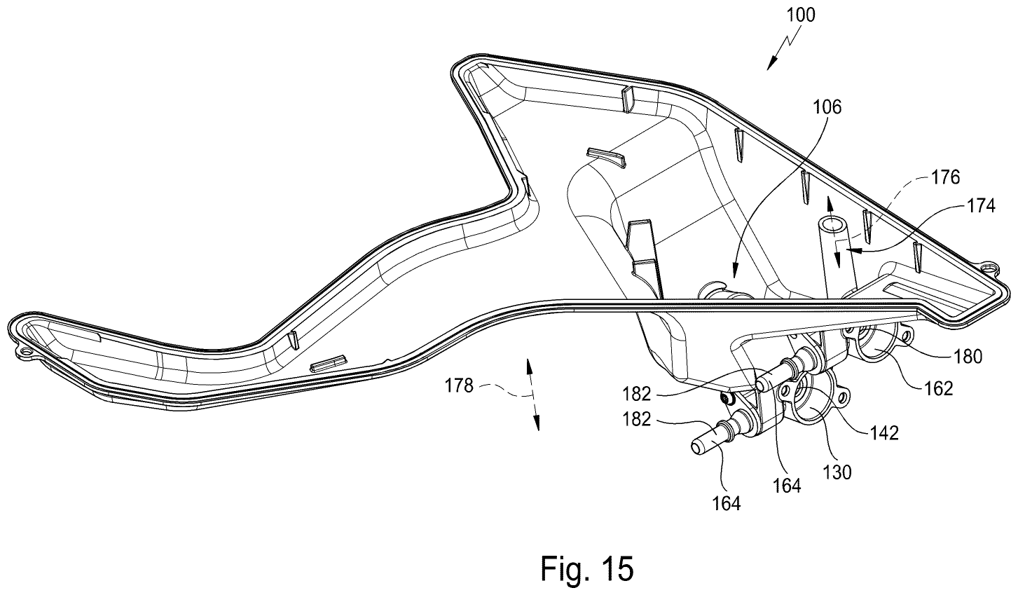

FIGS. 15 to 20 illustrate a further fluid conduction unit 100 which differs from the two other fluid conduction units 100 previously described in conjunction with FIGS. 1 to 9 and in conjunction with FIGS. 10 to 14.

FIG. 15 shows that the fluid conduction unit shown therein also has a liquid collection zone 106. A purge line 174 extends out of the liquid collection zone 106. The purge line 174 is formed tubular. It extends along a dispensing direction 176. Liquid that can be dispensed from the liquid collection zone can be dispensed along the dispensing direction 176 by means of a gas flow through the purge line 174 and a liquid dispensing opening 180 from the fluid conduction unit 100.

The liquid dispensing opening 180 opens in the embodiment shown here into a dispensing valve receptacle zone 162.

The dispensing direction 176 also extends parallel to the demolding direction 178 in the embodiment of the fluid conduction unit 100, shown in FIGS. 15 to 20.

FIG. 15 shows connection elements 164 which are embodied as nozzles 182. One of the connection elements 164 is arranged at the liquid passage opening 142 which leads into the valve receptacle zone 130. The other connection element 164 is arranged at the liquid dispensing opening 180 which leads into the dispensing valve receptacle zone 162.

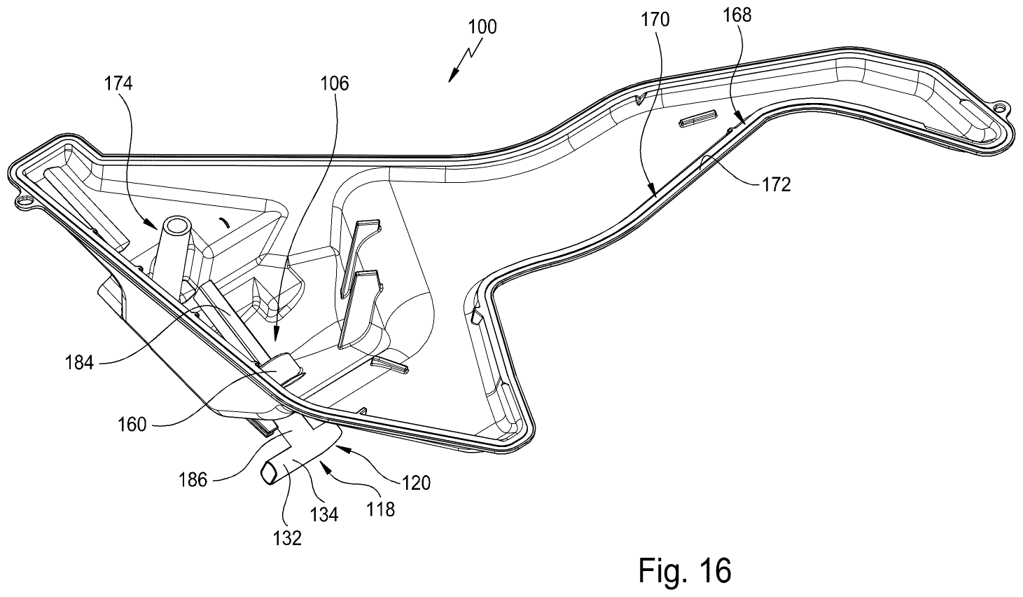

FIG. 16 shows that the fluid conduction unit 100 comprises a sealing zone 168. The sealing zone 168 comprises a flange zone 170. A circumferential depression 172, in which a sealing element can be received, is formed at the flange zone 170.

The fluid conduction unit 100 comprises a sensor unit 118. The sensor unit 118 is a sensor device 120.

The sensor unit 118 shown in FIG. 16 also comprises a connecting element 132 which can be, for example, a receptacle element 134, as was already described in more detail in conjunction with the sensor unit 118 shown in FIG. 2.

The sensor unit 118 is received in the sensor receptacle zone 160.

An inner section 184 of the sensor unit 118 extends out of the sensor receptacle zone 160 into the liquid collection zone 106. An outer section 186 of the sensor unit 118 extends out of the sensor receptacle zone 160 out of the fluid conduction unit 100. A sealing element (not shown here) can be arranged at the sensor receptacle zone, which can entirely or partially prevent liquid from emerging from the liquid collection zone 106 in the area between the sensor receptacle zone and the sensor unit 118.

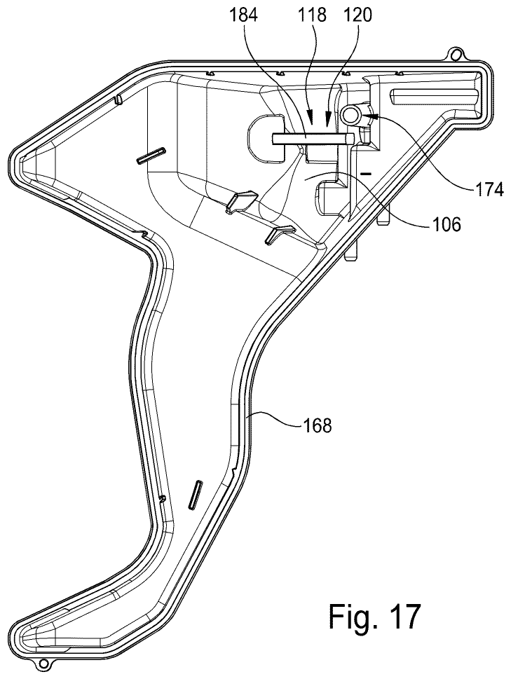

FIG. 17 shows the fluid conduction unit 100 from above, wherein the viewing direction of the observer essentially coincides with the dispensing direction 176 (not shown in FIG. 17) and the demolding direction 178. Therefore, the outer section 186 of the sensor unit 118, shown in FIG. 16, is covered, so that only the inner section 184 of the sensor unit 118 can be seen.

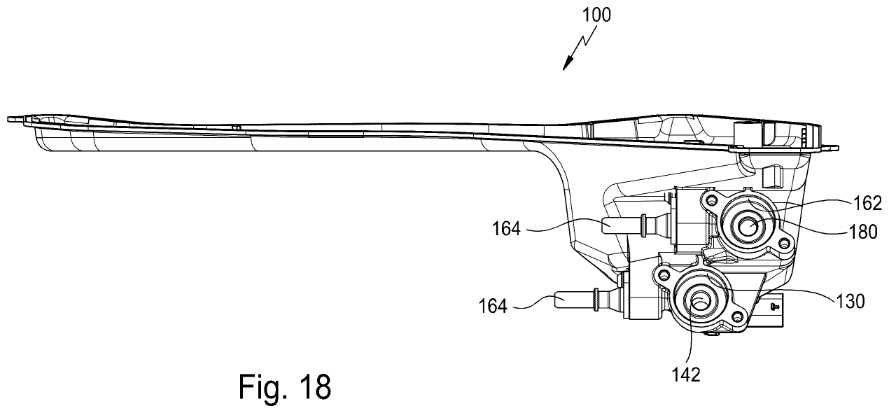

FIG. 18 shows a view of the fluid conduction unit 100, wherein in particular it can be seen clearly that a liquid dispensing opening 180 is formed on the dispensing valve receptacle zone 162 and that a liquid passage opening 142 is formed at the valve receptacle zone 130.

FIG. 18 also shows the corresponding connection elements 164.

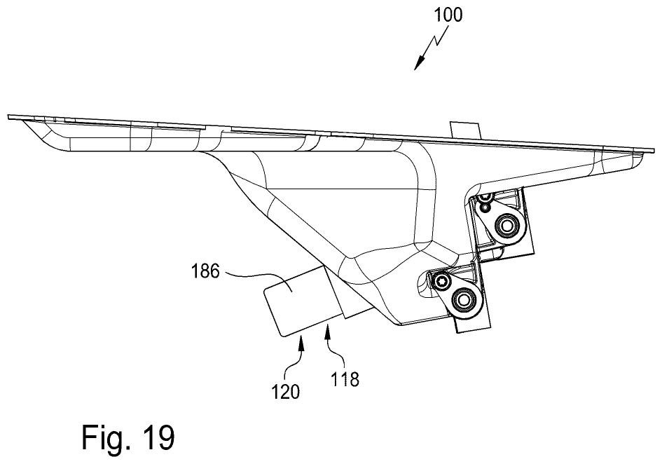

FIG. 19 shows a further view of the fluid conduction unit 100. In the view shown therein, only the outer section 186 of the sensor unit 118 can be seen.

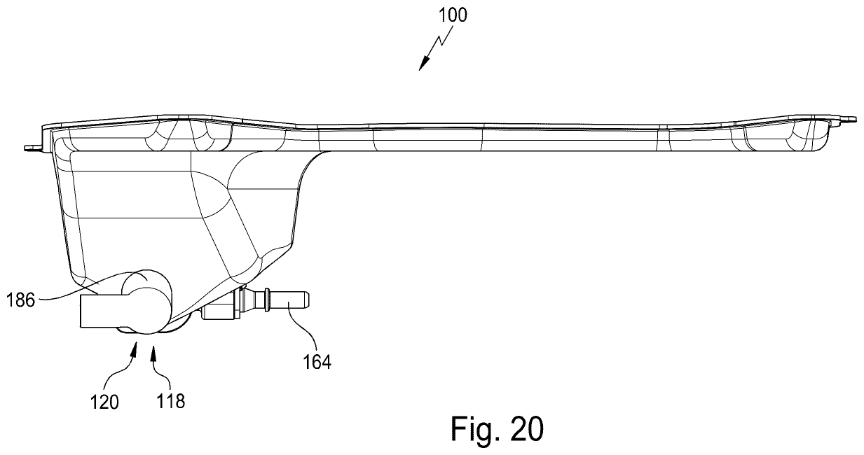

Only the outer section 186 of the sensor unit 118 can also be seen in the view shown in FIG. 20.

### LIST OF REFERENCE SIGNS

100 fluid conduction unit
102 cover element
104 base element
106 liquid collection zone
108 depression
110 fluid passage
112 liquid separation zone
114 channel zone
116 liquid passage
118 sensor unit
120 sensor device
122 liquid level detection zone
124 liquid detection zone
126 sensor zone
128 sensor surface
130 valve receptacle zone
132 connecting element
134 receptacle element
136 liquid level detection signal
138 deflection recognition signal
140 flow barrier
142 liquid passage opening
144 channel wall
146 deflection recognition unit
148 first direction
150 second direction
152 liquid
154 sensor matrix
156 sensor row
158 sensor column
160 sensor receptacle zone
162 dispensing valve receptacle zone
164 connection element
166 receptacle zone
168 sealing zone
170 flange zone
172 depression
174 purge line
176 dispensing direction
178 deforming direction
180 liquid dispensing opening
182 nozzle
184, 186 section

1. A sensor unit for a fluid conduction unit used to discharge liquid, wherein the sensor unit comprising:
at least one liquid level detection zone.

2. The sensor unit as claimed in claim 1, further comprising:
at least one deflection recognition unit for recognizing at least one deflection force which can act on a liquid collectible at the liquid level detection zone, or for recognizing an effect of the at least one deflection force.

3. The sensor unit as claimed in claim 2, wherein
the at least one deflection recognition unit comprises an acceleration sensor and/or an inclination sensor.

4. The sensor unit as claimed in claim 2, wherein
the at least one deflection recognition unit comprises multiple liquid level detection zones spaced apart from one another, or
the at least one liquid level detection zone can form at least one of the multiple liquid level detection zones spaced apart from one another.

5. The sensor unit as claimed in claim 2, wherein
the at least one deflection recognition unit comprises multiple liquid level detection zones spaced apart from one another in a first direction and multiple liquid level detection zones spaced apart from one another in a second direction, or
the at least one liquid level detection zone can form at least one of the multiple liquid level detection zones spaced apart from one another in a first direction and/or can form one of the multiple liquid level detection zones spaced apart from one another in a second direction.

6. The sensor unit as claimed in claim 4, wherein
the sensor unit comprises or is a sensor device, and
at least a part of the multiple liquid level detection zones spaced apart from one another can be liquid detection zones, or
at least three of the multiple liquid level detection zones spaced apart from one another are sensor zones of the sensor device.

7. A fluid conduction unit for discharging liquid, the fluid conduction unit comprising:
a liquid collection zone; and
at least one liquid level detection zone arranged in the liquid collection zone, wherein
the at least one liquid level detection zone can be a liquid level detection zone of a sensor unit as claimed in claim 1, and/or
the at least one liquid level detection zone can enable a detection and distinction of a plurality, or at least 3, or at least 4, different liquid levels in the liquid collection zone, wherein
a level of a liquid, which is collectible in the liquid collection zone, is detectable at the at least one liquid level detection zone.

8. The fluid conduction unit as claimed in claim 7, further comprising:
a sensor device, wherein
the multiple liquid level detection zones spaced apart from one another are sensor zones of the sensor device, which are arranged inside the liquid collection zone.

9. The fluid conduction unit as claimed in claim 7, further comprising:
a controllable discharge valve for discharging liquid which is collectible in the liquid collection zone.

10. A fuel cell device comprising:
the fluid conduction unit as claimed in claim 7, wherein
the discharge of liquid collecting in the liquid collection zone of the fluid conduction unit as claimed in claim 7, or of liquid collectible therein can take place through a controllable discharge valve, wherein the discharge valve is controlled according to:
a detection of a liquid at the at least one liquid level detection zone arranged in the liquid collection zone, and/or
a recognition of at least one deflection force, which can act on a liquid collectible at the liquid level detection zone, or a recognition of an effect of the at least one deflection force.

11. The fuel cell device as claimed in claim 10,
the fuel cell device comprises a control system or is connected to the control system or the control system is connected or connectable to said sensor unit, wherein
the discharge valve is completely or partially controllable or controlled by the control system.

12. A method for controlling a discharge valve for discharging liquid from a liquid collection zone, wherein the discharge valve is controlled according to:
at least one liquid level detection signal, which can originate from at least one liquid level detection zone arranged in the liquid collection zone, and/or
at least one deflection recognition signal, which can originate from at least one deflection recognition unit and which can stem from:
the recognition of a deflection force, which acts on a liquid collectible at the at least one liquid level detection zone, and/or
the recognition of an effect of this deflection force.

13. The method for controlling a discharge valve as claimed in claim 12, wherein the discharge valve is controlled according to the at least one liquid level detection signal and the at least one deflection recognition signal.

14. The method for controlling a discharge valve as claimed in claim 12, wherein the discharge valve is additionally controlled according to:
a pressure prevailing in the liquid collection zone, or a difference between the pressure prevailing in the liquid collection zone and an ambient pressure.

15. The method for controlling a discharge valve as claimed in claim 14, wherein a duration of an opening interval, in which the discharge valve adopts an open state, is controlled according to:
the at least one liquid level detection signal and/or the at least one deflection recognition signal, or the at least one liquid level detection signal and the at least one deflection recognition signal, and/or
the pressure prevailing in the liquid collection zone, wherein
a duration of an opening interval, in which the discharge valve adopts an open state, can be controlled according to:
the at least one liquid level detection signal and/or the at least one deflection recognition signal, or the at least one liquid level detection signal and the at least one deflection recognition signal, and/or
the pressure prevailing in the liquid collection zone.

16. The method as claimed in claim 15, wherein
the control valve is closed before a gas flows out of the liquid collection zone through the discharge valve.

17. A method for controlling the fuel cell device as claimed in claim 10, wherein the fuel cell device is controlled according to:
at least one liquid level detection signal, which can originate from at least one liquid level detection zone arranged in the liquid collection zone, and/or
at least one deflection recognition signal, which can originate from at least one deflection recognition unit and which can stem from:
the recognition of a deflection force, which acts on a liquid collectible at the at least one liquid level detection zone, and/or
the recognition of an effect of this deflection force, wherein
the fuel cell device is transferred from a higher-performance into a lower-performance operating state or into a switched-off state when:
the at least one liquid level detection signal indicates reaching or exceeding a fill level threshold value in the liquid collection zone, and/or
the at least one deflection recognition signal indicates reaching or exceeding a deflection force threshold value of the deflection force or indicates an effect of the at least one deflection force which indicates reaching or exceeding the deflection force threshold value.

18. A control system designed and configured to control a discharge valve and/or to control a fuel cell device, the control system comprising:
an interface for receiving at least one liquid level detection signal,
an interface for receiving at least one deflection recognition signal, and
an interface for emitting a signal to the discharge valve and/or an interface for emitting a signal for controlling the operating state of the fuel cell device.

19. A motor vehicle comprising:
a sensor unit,
a fuel cell device, and
the control system as claimed in claim 18, wherein
the sensor unit is connected to the control system so that at least one liquid level detection signal and/or at least one deflection recognition signal is receivable by the control system, and
the control system is connected to the discharge valve so that a signal emitted by the control system is transmittable to the discharge valve.

20. The motor vehicle as claimed in claim 19, wherein
a signal generated by an acceleration sensor and/or an inclination sensor is used not only to control the discharge valve.
